(19) United States
(12) Patent Application Publication
(10) Pub. No.: US 2026/0071465 A1
(43) Pub. Date: Mar. 12, 2026

(54) A LOCK AND A METHOD FOR MANUFACTURING A KEY

(71) Applicant: HENRY SQUIRE & SONS HOLDINGS LTD, Wolverhampton (GB)

(72) Inventors: John CHARNLEY, Wolverhampton (GB); Glyn GREEN, Wolverhampton (GB); Mason EVANS, Wolverhampton (GB)

(73) Assignee: HENRY SQUIRE & SONS HOLDINGS LTD, Wolverhampton (GB)

(21) Appl. No.: 19/102,826

(22) PCT Filed: Aug. 14, 2023
(86) PCT No.: PCT/GB2023/052139

§ 371 Date: Feb. 10, 2025

(30) Foreign Application Priority Data
Aug. 15, 2022 (GB) 2211874.9

(51) Int. Cl. E05B 27/00; E05B 19/18; E05B 27/10

(52) U.S. Cl. CPC E05B 27/0007; E05B 19/18; E05B 27/0017; E05B 27/0082; E05B 27/10

(57) ABSTRACT

A lock and key and method of forming same are disclosed. The lock includes a cylinder and a plug which has a keyway for receiving a key. The plug is moveable (rotatable) relative to the cylinder. There are multiple pins slidable within the plug and the pins have a first recess with a cam surface for engaging a key so as to cause sliding movement and a second recess for receiving a locking member. The locking member allows and prevents the rotation of the plug in the cylinder only allowing rotation when all of the first recesses are aligned with the locking member. The key has a head and a blade with the blade having multiple peg receivers with a plurality of peg locations in each receiver. Each peg location has a peg fixed into one of the peg receiver and the pegs move the pins to determine whether the lock can be opened.

The present invention relates to a lock and a method for manufacturing a key and relates particularly, but not exclusively, a cylinder lock and associated key.

The use of locks using pins and side bars is known in locking devices. These locks differ from the standard Euro cylinders due to their unique pins and use of a side bar. An example of such a locking device is disclosed in US2002056301.

This document describes the use of a biased side bar whilst incorporating moveable pins. The key is formed of a longitudinal recess that engages with protrusions in the pins moving them into an unlocked condition.

The type of key disclosed in US2002056301 is quite different from those seen in standard cylinder locks making them difficult to replicate both for legitimate and illegitimate purposes. This is advantageous for those using the lock as it is less likely to be overcome using standard lock breaking and lockpicking techniques. However, locksmiths require additional specialist tools in order to produce duplicate keys significantly increasing the cost of producing such duplicates. As a result, keys of this type of primarily only used keys such as cars keys where additional electronic security is typically included thereby requiring duplicates to be produced by specialists.

Preferred embodiments of the present invention seek to overcome or alleviate the above described disadvantages of the prior art.

According to an aspect of the present invention there is provided
a lock comprising:
a casing;
a body having a keyway for receiving a key, said body being moveable relative to said casing;
a plurality of pins slidably located within said body, said pins comprising a first recess having a cam surface for engaging a key so as to cause sliding movement of said pin and further comprises a second recess; and
at least one locking member for allowing and preventing said relative movement of said body, wherein when all said second recesses are aligned with said locking member said relative movement is allowed by said locking member entering said second recesses.

Having pins with a first recess and cam surfaces allows for smooth and simple engagement with a key. The second recesses also allow for easy engagement with the locking member. Compared to the device in US2002056301 this lock has all of the advantages of the device disclosed in that document but in addition, the keys used do not require specialist equipment for manufacturing and for duplication. As a result, locksmiths are not required to purchase additional specialist equipment and can use standard tools of the trade. Furthermore, keys used in connection with locks of this type can be produced using additive manufacturing techniques. One such technique is the use of pegs which are inserted into apertures in the blade of a key and this is easily achieved using the standard tools of a locksmith and can even be done by a layman using tools which are commonly found in a home workshop. These types of pins are easy to manufacture and produce structurally strong pins that can withstand movement via the key for a long time.

In a preferred embodiment said second recess of each said pin is in one of a plurality of locations.

If the first recess is in the same location on each of the pins and the second recess is in one of a few positions on the pins, the many positions for the second recesses creates a multitude of various types of pins that can be used for the lock. For example, if there are a trio of different shaped pins and the lock has twelve pin locations this allows for 531, 441 lock combinations. If two of the pins are mirror images of each other only two pins need to be designed and manufactured.

In another preferred embodiment said locking member is biased by a biasing member towards said casing.

In an additional preferred embodiment said lock further comprises a plurality of locking members.

Having two locking members increases the security of the lock and allows for two rows of pins to engage with the locking members. More pins, and more protrusions on the key, provides more combinations of configurations for the key making it harder to overcome.

In a further embodiment the pins are located at opposing sides of said keyway.

In another embodiment the first and said second recesses are on opposing sides of said pin and may further comprise a plurality of cam surfaces and are connected to each other or are located on opposing sides of said first recess.

The pins having a first recess with a cam surface allows for effortless and smooth engagement of the key when being inserted or pulled from the lock therefore increasing their reliability and lifetime. Furthermore, the orientation of the lock does not affect its function. If less cam surfaces are used it is necessary to include springs to move the pins or ensure a specific orientation and use gravity to return the springs to a locked condition.

The pin may also further comprise a third and fourth cam surface located opposing said first and second cam surfaces.

In an additional embodiment said key may further comprise a head and blade, the blade having a plurality of protrusions extending therefrom.

In a further embodiment said casing comprises a cylinder and said body comprises a plug rotatable within said cylinder.

According to another aspect of the present invention there is provided a key comprising:

### A HEAD; AND

a blade having a plurality of protrusions extending therefrom, wherein upper and lower edges of said blade are substantially linear.

By having a key with a linear edged blade and protrusions extending therefrom, a simple key can be formed by additive manufacturing processes such as 3D printing or by the insertion of pegs into receiving recesses in the blade. The key is therefore relatively easily replicated. Furthermore, if the protrusions are located in one of a plurality of positions, that is each protrusion has a set horizontal distance along the blade and can be in one of a few vertical positions for that horizontal position then the key can be defined as a code meaning that an original key does not need to be present for a duplicate to be made. For example, there are three vertical positions for a protrusion at each horizontal position these could be labelled A, B and C. A code for a six protrusion key could then be defined as ABCBAC. As a result, a key can be duplicated based just on this code and there is no loss of key accuracy in the reproduction process.

In a preferred embodiment said blade further comprises first and second faces on an opposing sides of said blade and said protrusions are located on said first and second faces and said protrusions may further comprise at least three protrusions on each of said first and second face.

According to an additional aspect of the present invention there is provided a key comprising:
a head;
a blade having a plurality of peg receivers and said peg receivers having a plurality of peg locations; and
a plurality of pegs located in said peg receivers.

In a preferred embodiment the peg receivers may further comprise at least three peg locations and said blade may further comprises first and second faces on an opposing sides of said blade and said protrusions are located on said first and second faces.

According to a further aspect of the present invention there is provided a kit of parts for forming a key, the kit comprising:
a key blank comprising a head and a blade, said blade having a plurality of peg receivers and said peg receivers having a plurality of peg locations; and
a plurality of pegs for location in said peg receivers.

Having a simple blank key with peg receivers and at least two positions enable simple crafting of many keys without any machinery.

According to another aspect of the present invention there is provided a method of manufacturing a key comprising the steps:
depositing material to create a head and blade of a key; and
depositing material on a first face of said blade to form a plurality of first protrusions.

The method may further comprise depositing material on a second face of said blade to form a plurality of second protrusions, wherein said second face is on an opposing side of said first face.

According to an additional aspect of the present invention there is provided a method of manufacturing a key comprising the steps:
providing a key blank, said key blank comprising a head and a blade having a plurality of peg receivers and said peg receivers having a plurality of peg locations; and
pressing a plurality of pegs into said peg locations.

Preferred embodiments of the present invention will now be described, by way of example only, and not in any limitative sense with reference to the accompanying drawings in which:

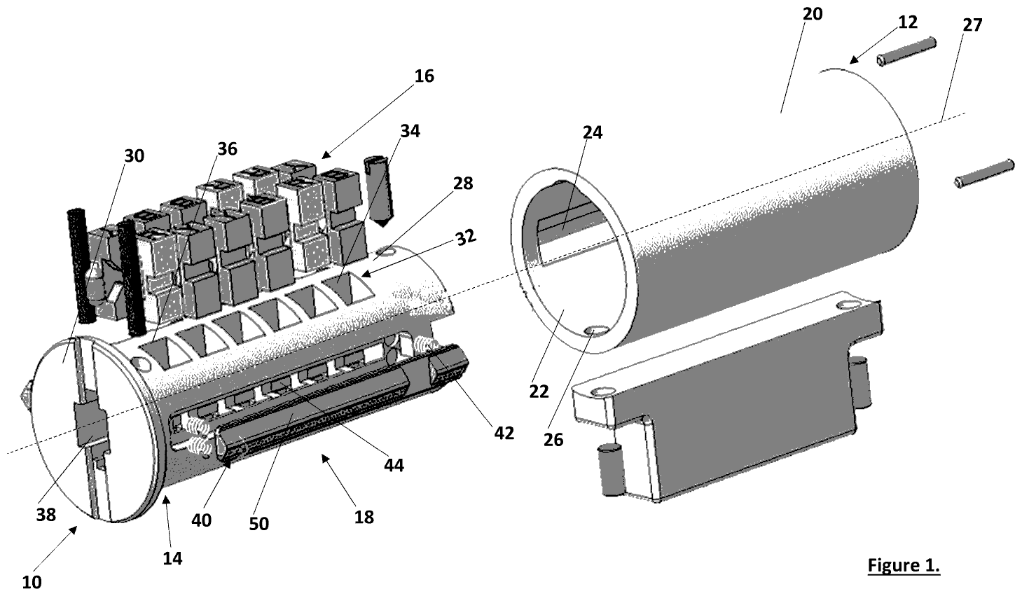

FIG. 1 is an exploded perspective view of the lock of the present invention;

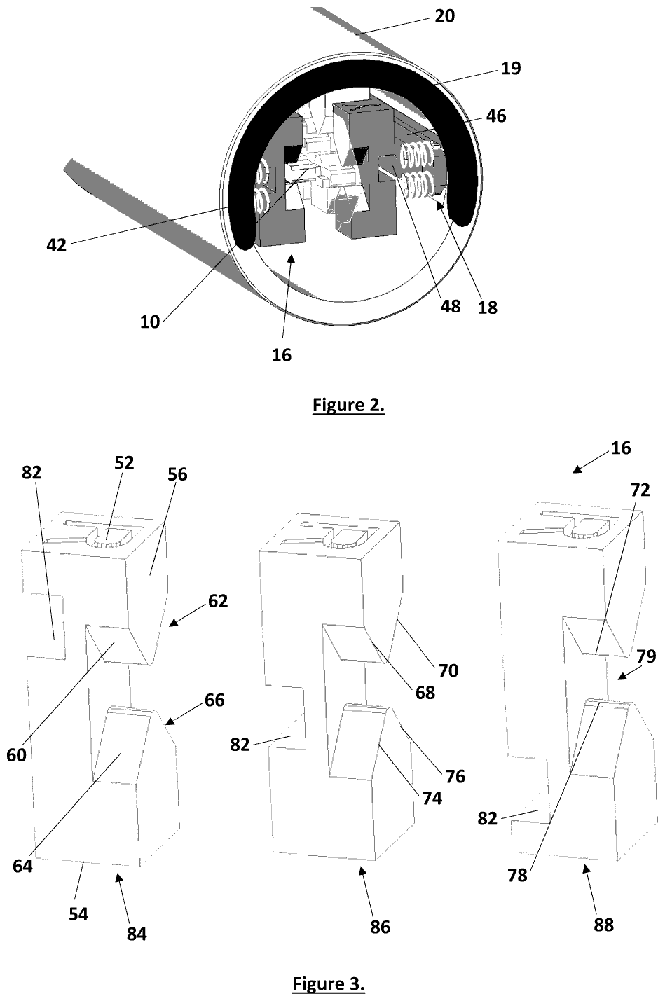

FIG. 2 is a perspective view of the lock of FIG. 1;

FIG. 3 is a perspective view of pins of the lock of FIGS. 1 and 2;

FIG. 4 is a perspective view of a key of the present invention;

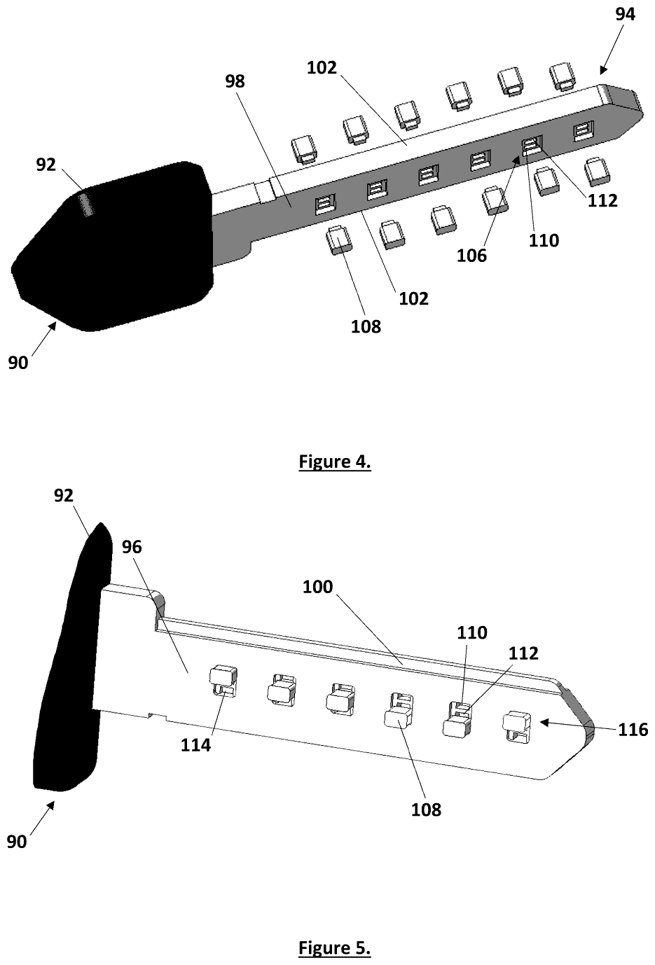

FIG. 5 is a sectional view of the key of FIG. 4; and

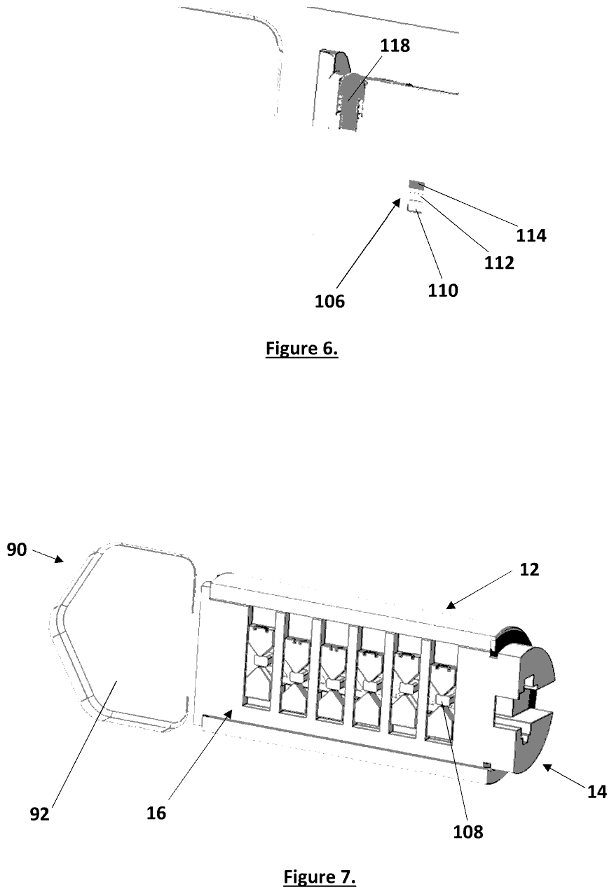

FIG. 6 is a sectional view of the key inserted into the lock of FIGS. 1 and 4.

Referring initially to FIGS. 1 and 2 there is provided a lock 10 having a casing in the form of a cylinder 12, a body in the form of a plug 14, a plurality of pins 16 and a pair of locking members 18.

The cylinder 12 provides housing and protection for the internal components of the lock 10. It is cylindrical in shape and has a first outer curved surface 20 and a first inner curved surface 22. Located within the inner curved surface 22 of the cylinder 12 are a pair of first locking member recesses 24 each having a cam surface 25 for engaging the locking members 18, and a pair of first apertures 26.

The plug 14 provides housing for the pins 16 and is rotatable within the cylinder 12. With the boundary between cylinder 12 and the plug 14 defining the shear line 19. The sheer line 19 can be regarded as the junction of the cylindrical internal surface of the cylinder 12 and the external cylindrical surface of the plug 14, running parallel to an axis 27 of the plug and cylinder.

The plug 14 has a second outer curved surface 28 and a base 30. Along the second outer curved surface 28 are two rows of pin recesses 32. In the example shown there are a total of six pin recesses 32 in each row located at opposing sides of the plug 14, with each pin recess housing a single pin 16. The pin recesses 32 are cuboidal in shape and include a first wall 34 and a second wall 36, being opposite the first wall. The walls have a depth long enough to allow the pins free movement along the recesses 32, that is transverse to the axis 27. The width and breath of the pin recesses 32 match the equivalent dimensions of the pins 16 such that the pins 16 are only allowed to move along the recesses and are prevented from free rotational movement within.

Starting from the base 30 and running along the central axis of the plug 14, in between the two rows of pin recesses 32 is a keyway 38 for a key 90. The keyway 38 is a longitudinal recess, coaxial with the axis 27 of the cylinder and plug, and is connected to each of the first walls 34 of the pin recesses 32 via a second aperture (not shown).

Also running parallel to the central axis 27 of the plug 14 along the second curved outer surface 28 are a pair of second locking member recesses 40. The second locking member recesses 40 are also connected to the second walls 36 via a third aperture 44 of the pin recesses 32. At opposing ends of the second locking member recess 40 are located a pair of biasing members, in the form of helical springs 42. These springs 42 bias the locking member 18 towards the first inner curved surface 22 of the cylinder 12.

The locking members 18 are long bars that fit into both the first locking member recesses 24 of the cylinder 12 and the second locking member recesses 40 of the plug 14. With the shear line 19 being located in the junction between the cylinder 12 and the plug 14. The locking member 18 can be described as either straddling the shear line 19 or not. If the locking member 18 is straddling the shear line and is prevented from moving radially inwards, the lock 10 is in a locked condition. If the locking member 18 is able to move radially inwards towards the axis 27, so that it is not straddling the shear line 19, the lock 10 is in an unlocked condition.

With additional reference to FIG. 8, a projection 48 is located along a first locking member surface 46 of the locking member 18. This projection 48 aligns with the third aperture 44 of the pin recesses 32. On the opposing side of the first locking member surface 46 is a second locking member surface 50. This surface has a triangular cross-section and matches the shape of first locking member recess 24 of the cylinder 12. When the lock is in a locked condition the second locking member surface 50 abuts the surface of the first locking member recess 24 by the force of the spring 42, denying rotation of the plug 14 within the cylinder 12.

Referring now to FIG. 3 the pins 16 are cuboidal in shape and have a square transverse cross-section at a second surface 52 and a square transverse cross-section at a third surface 54. The pins 16 being located within the pin recess 32 of the plug 14 require this cross section to prevent any rotational movement. Located on a first side 56 of the pin 16 is a first recess 58. The first recess 58 has a first, second, third and fourth cam surface 60, 62, 64 and 66 respectively extending therefrom. The first and second cam surfaces 60 and 62 are located adjacent the second surface 52, whilst the third and fourth cam surfaces 60 and 62 are located adjacent the third surface 54. Together the first and second cam surfaces 62 and 64 form a first and second chamfered edge 68 and 70 connecting together at a first rounded apex 72. The third and fourth cam surfaces 64 and 66 form a third and fourth chamfered edge 74 and 76 connecting together at a second rounded apex 78. The first rounded apex 72 facing directly opposite the second rounded apex 78 and a gap 79 situated between them.

Located on a second side 80 is a second recess 82. The second recess is cuboidal and is sized to allow insertion of the projection 48 of the locking member 18. The position of this second recess 82 relative to the second and third surface 52 and 54 defines three variations of the pins 16. The first variation has the location of the second recess 82 closer to the second surface 52. The second variation 86 has the location of the second recess 82 mid-way between the second and third surface, 52 and 54. Finally the third variation has the second recess 82 located closer to the third surface 54. However, it should be noted that the third variation 88 is essentially the first variation 84 turned upside down and therefore only two forms of the pins 16 need to be produced. A code could be associated with the different pin variations. For example, the first variation is assigned the number 1, the second variation assigned the number 2 and the third variation assigned the number 3. Therefore, if a certain combination of the various pins is required, a code (in a simplified 3 pin lock, such as 1, 2, 1) will allow the user to know what pin variations should go in which pin recess.

When inserting the pins 16 into the pin recesses 32 the orientation of the pins is important. The first recess 58 being adjacent the keyway 39, enables the first recesses 58 to align with the second apertures along the first walls 34 of the pin recesses 32. The second recesses 82 are positioned adjacent the third aperture 44 of the second locking member recess 40. When a key 90 is inserted into the keyway the pins 16 slide either up or down depending on the location of the second recesses 82.

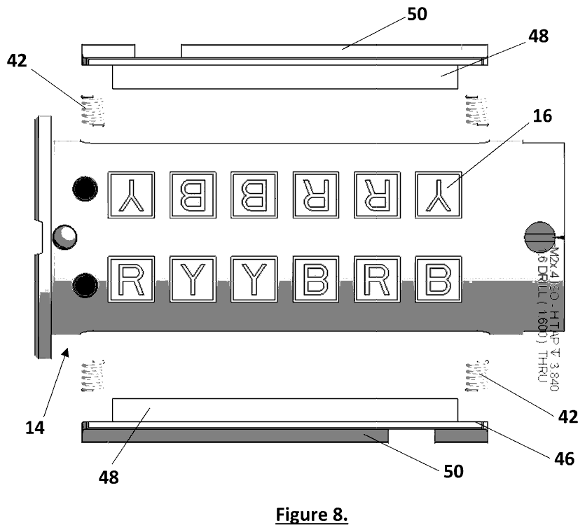

Referring now to FIGS. 4 to 7 the key 90, for insertion into the keyway 38 and engaging the pins 16, has a head 92 and a blade 94. The head 92 forms the gripping portion of the key 90 with the blade 94 extending therefrom. The blade 94 has a first face 96 and an opposing second face 98. With the first and second faces 96 and 98 connected along a substantially linear upper and lower edge 100 and 102.

Located longitudinally along the first and second faces 96 and 98 are a row of six peg receivers 104. The peg receivers 104 are small rectangular recesses within the first and second faces 96 and 98. Each peg receiver 104 has a trio of additional indentations forming peg locations 106. These peg locations 106 are aligned in a column and define the positions of the pegs 108, a first peg location 110, second peg location 112 and third peg location 114, with the first peg location 110 always being above the third peg location 112. £ When a single peg 108 is inserted into one of the three peg locations 106 within the peg receivers 104, each peg 108 extends past the first and second faces, 96 and 98 of the key 90. Once inserted, the pegs 108 on the first face 96 form the first protrusions 116 of the key 90 and the pegs 108 on the second face 98 form the second protrusions of the key 90.

In a simplified example of a lock used for illustrative purposes, if the pins 16 related with the lock 10 are arranged from left to right and have the associated codes 1,2,3 on the first row and the code 2,3,2 on the second row, the key 90 coupled with this lock 10 will have the following peg 108 combinations. The first code 1,2,3 informs the user that the first pin 16 in this row has a first variation 86 type pin, indicating the second recess 82 is located adjacent the second surface 52, requiring the key 90 to have peg 108 located in the first peg location 110. The second pin in this row has a second variation 86 type pin, indicating the second recess 82 on this pin is located mid-way between the second and third surfaces 52 and 54. Therefore requiring the peg 108 to be located in the second peg location 112 in the middle peg receiver 104. The third pin 16 in this row has a third variation 88 type pin, requiring the key to have a peg 108 in the third peg location 114 in the final peg receiver 104. This arrangement is then repeated across the second row of peg receivers 104 located on the second face 98 of the blade 94, producing a key that will match the lock 10. The above example has three pin on either side of the keyway and three protrusions on either side of the blade. However, the key shown in the figures uses a total of twelve pins and protrusions with six on either side. Another example of a similar code that could be used to decipher the different pins is a colour letter code. For example, Y, R, B or yellow, red and blue, as illustrated in FIG. 8.

The method of forming the key 90 using pegs allows the key to be replicated easily without the requirement for specialist tools. In the example set out above, the pegs 108 fit into the peg locations 106 with a very tight interference fit which is sufficiently secure to allow the pegs to move the pins 16. The security of the pegs 108 within the peg locations 106 can be enhanced with the additional use of strong adhesive or other technique for locking the pegs into position. Another method of forming the key is by 3D printing. If a user knows the code associated with the key, and therefore the position of the pegs 108 along the key faces, the key can be duplicated using 3D printing.

The sectional view of the key 90 in FIG. 5 further highlights a trapping pin 118 that is used to retain the key 90 upon rotation. This is to prevent any possible axial movement of the key once rotation is initiated and to prevent extraction of the key during use.

The mechanism method of operation of the lock 10 will now be described. When the user has the correct key 90 for an associated lock 10 the user inserts that key 90 into the keyway 38. As the key moves longitudinally down the plug 14, each peg 108, located on the first and second faces 96 and 98 of the key 90, engages with the cam surfaces of the pins 16. As the key 90 reaches the end of the keyway 38 the protrusions 110 are located within the gaps 79 of the first recesses 58 of the pins 16. Because the correct key has been used, the pins are moved by the pegs such they each of the second recesses 82 align with the second locking member recesses 40 located in the plug 16, allowing the projection 48 of the locking members 18 to line up with the second recesses 82 of pins 16.

As the key is turned the locking member 18 engages with the cam surfaces of the first locking member recesses 24 of the first inner curved surface 22 located in the cylinder 12. As the key is continued to be turned, thereby rotating the plug 14 within the cylinder 12, the locking members 18 continue to make contact with the cam surface 25 until it engages with the first inner surface 22 of the cylinder. Once this occurs the locking members 18 have moved radially inwards against the biasing action of the helical springs 42 and thereby allowing the projection 48 to engage with the second recesses 82 of the pins 16. This engagement allows the user to turn the key further so that the locking member 18 is not straddling the shear line 19 unlocking the lock 10.

It will be appreciated by persons skilled in the art that the above embodiments have been described by way of example only and not in any limitative sense, and that various alterations and modifications are possible without departure from the scope of the protection which is defined by the appended claims. For example, the above embodiment has been described using the commonly used plug and cylinder arrangement with the shear line defined on the boundary between the plug and the cylinder. However, the mechanism would also work using linear motion sliding between a body and casing, such as might be used in a sliding bolt lock or a clasp/seatbelt type lock.

Another example is the number of pin recesses located within the plug. There are two rows of pin recesses as defined above to house a total of twelve pins. However, any number of recesses or pins could be utilised depending on how many combinations are required. This also includes the number of pegs and peg receivers within the key. Example if there are only six pins only six pegs or protrusions are required. The above embodiments have been described utilising twelve pins/pegs with three peg positions and this gives over half a million possible key combinations. However, if less pins/pegs are used but with four peg positions over one million combinations can be created using ten pins and pegs. Even using four peg positions still allows two different pins to accommodate the four peg locations. These locations would be top, upper middle, lower middle and bottom but the bottom and lower middle can be just the top and upper middle inverted.

We claim:

1. A lock comprising:
a casing;
a body having a keyway for receiving a key, said body being moveable relative to said casing;
a plurality of pins slidably located within said body, said pins comprising a first recess having a cam surface for engaging a key so as to cause sliding movement of said pin and further comprises a second recess; and
at least one locking member for allowing and preventing said relative movement of said body, wherein when all said second recesses are aligned with said locking member said relative movement is allowed by said locking member entering said second recesses.

2. The lock of claim 1 wherein, said recess of each said pin is in one of a plurality of locations.

3. The lock of claim 1 wherein, said locking member is biased by a biasing member towards said casing.

4. The lock of claim 1, wherein said lock further comprises a plurality of locking members.

5. The lock of claim 1, wherein said pins are located at opposing sides of said keyway.

6. The lock of claim 1, wherein said first and said second recesses are on opposing sides of said pin.

7. The lock of claim 1, wherein said first recess of said pin further comprises a plurality of cam surfaces.

8. The lock of claim 7, wherein said plurality of cam surfaces comprise a first cam surface and a second cam surface.

9. The lock of claim 8, wherein said first and second cam surfaces are connected to each other.

10. The lock of claim 8, wherein said first and second cam surfaces are located on opposing sides of said first recess.

11. The lock of claim 8, wherein said pin further comprises a third and fourth cam surface, said third and fourth cam surfaces are located opposing said first and second cam surfaces.

12. The lock of claim 1 wherein said key further comprises a head and blade, said blade having a plurality of protrusions extending therefrom.

13. The lock of claim 1, wherein said casing comprises a cylinder and said body comprises a plug rotatable within said cylinder.

14. A key comprising:
a head; and
a blade having a plurality of protrusions extending therefrom, wherein upper and lower edges of said blade are substantially linear.

15. The key of claim 14, wherein said blade further comprises first and second faces on an opposing sides of said blade and said protrusions are located on said first and second faces.

16. The key of claim 14, wherein said protrusions further comprise at least three protrusions on each of said first and second face.

17. A key comprising:
a head;
a blade having a plurality of peg receivers and said peg receivers having a plurality of peg locations; and
a plurality of pegs located in said peg receivers.

18. The key of claim 17, wherein said peg receivers further comprise at least three peg locations.

19. The key of claims 17, wherein said blade further comprises first and second faces on an opposing sides of said blade and said protrusions are located on said first and second faces.

20.-23. (canceled)
